(19) United States
(12) Patent Application Publication
(10) Pub. No.: US 2008/0126655 A1
(43) Pub. Date: May 29, 2008

(54) SINGLE PCI CARD IMPLEMENTATION OF DEVELOPMENT SYSTEM CONTROLLER, LAB INSTRUMENT CONTROLLER, AND JTAG DEBUGGER

(76) Inventors: HEINZ BAIER, Singelfingen (DE); ROBERT W. BERRY, Round Rock, TX (US); CHRISTOPHER R. CONLEY, Pflugerville, TX (US); MICHAEL CRISCOLO, Cedar Park, TX (US); CHRISTOPHER J. KURUTS, Round Rock, TX (US); MICHAEL T. SAUNDERS, Round Rock, TX (US); STEVEN J. SMOLSKI, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/470,497

(22) Filed: Sep. 6, 2006

(51) Int. Cl. G06F 13/00; G06F 15/177

(52) U.S. Cl. 710/301; 713/2

(57) ABSTRACT

A system for integrating multiple electrical system testing functions into a single peripheral component interconnect (PCI) card. The functions of system bring-up and debug are integrated into a single PCI card, which utilizes an operating system and a set of industry standard interfaces to interconnect with standard lab instrumentation. The integrated PCI card utilizes an embedded high performance microprocessor and a compact operating system to provide control over: system-under-test (SUT) power on/off; system device sequencing via programmable General Purpose Input/Output (GPIO); system parametric control (e.g. voltage, temperature, and frequency); system parametric measurement; system debug; and remote control operation via internet interface. In one embodiment, the integrated PCI card comprises the instrumentation controller, Joint Test Action Group (JTAG) Debugger, SUT system controller, and a computer-controlled GPIO card in a single, self aware, half-slot PCI card.

### CROSS REFERENCE TO RELATED APPLICATIONS

The present application is related to the following U.S. patent applications filed concurrently herewith: U.S. patent application Ser. No. ______ (Docket No. AUS920060407US1); U.S. patent application Ser. No. ______ (Docket No. AUS920060408US1); and U.S. patent application Ser. No. ______ (Docket No. AUS920060409US1). The above-mentioned patent applications are assigned to the assignee of the present invention and are incorporated herein by reference in their entirety.

### BACKGROUND OF THE INVENTION

1. Technical Field

The present invention relates in general to the field of electronic systems and in particular to the testing of electronic devices. Still more particularly, the present invention relates to an improved method and system for integrating multiple testing functions into a single peripheral component interconnect (PCI) card.

2. Description of the Related Art

The testing of electronic systems is a complex process, which typically involves verifying the performance of many devices. Conventional electronic system testing typically utilizes several independently controlled and monitored testing components and requires an interface layer of software and/or hardware interconnects, such as the Peripheral Component Interconnect (PCI) standard. During system testing, a system controller apparatus is utilized to analyze and debug the system under test (SUT).

The utilization of multiple discrete electronic system testing components and their corresponding control systems is expensive and may also be problematic for testing teams who require a round the clock access to system development resources from multiple geographic locations. Due to the complexity of conventional systems, each independent testing component must typically be handled via direct physical contact. The requirement for human interaction thus limits the possibility of remote access to (and control over) both the testing equipment and the SUT itself. The present invention thus recognizes that an improved method and system for integrating multiple testing functions into a single accessible PCI card is needed. Furthermore, the present invention also recognizes that it is desirable to have a system controller that is independent of the functionality of the SUT and is fully capable of controlling all system sequences as well as interfacing with external hosts, such as debug devices, external instruments, and test equipment.

### SUMMARY OF THE INVENTION

Disclosed is a method and system for integrating multiple electrical system testing functions into a single peripheral component interconnect (PCI) card. In accordance with an embodiment of the present invention, the functions of system bring-up and debug are integrated into a single PCI card, which utilizes an operating system and a set of industry standard interfaces to interconnect with standard lab instrumentation. The integrated PCI card utilizes an embedded high performance microprocessor and a compact operating system to provide control over the following: system-under-test (SUT) power on/off; system device sequencing via programmable General Purpose Input/Output (GPIO); system parametric control (e.g. voltage, temperature, and frequency); system parametric measurement; system debug; and remote control operation via internet interface. In one embodiment, the integrated PCI card comprises the instrumentation controller, Joint Test Action Group (JTAG) Debugger, SUT system controller, and a computer-controlled GPIO card in a single, self aware, half-slot PCI card. The integrated PCI card also includes a common, stable operating system. A user may thereby control any portion of the SUT power sequence and all Inter-Integrated Circuit (I2C) and/or Serial Peripheral Interface (SPI) devices within the SUT. Furthermore, the present invention allows the user to set and measure external system parameters, such as temperature, voltage, and frequency, to control IEEE-488 based instrumentation, such as oscilloscopes and logic analyzers, and to utilize JTAG components in order to debug the SUT.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an integrated controller, according to one embodiment of the present invention; and

FIG. 2 illustrates an exemplary functional flow diagram of the integrated controller of FIG. 1, in accordance with an embodiment of the present invention.

### DETAILED DESCRIPTION OF AN ILLUSTRATIVE EMBODIMENT

The present invention provides a method, system, and computer program product for integrating multiple electrical system testing functions into a single peripheral component interconnect (PCI) card.

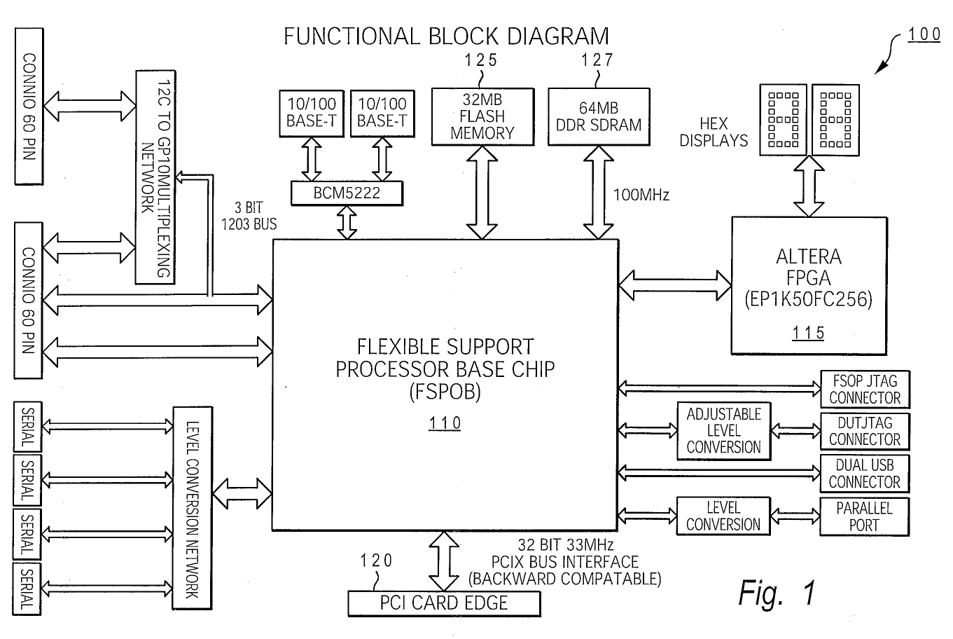

With reference now to FIG. 1, there is depicted a high level block diagram of an integrated controller, integrated PCI card 100. Integrated PCI card 100 comprises flexible support processor base chip (FSPOB) 110, and field programmable gate array (FPGA) 115. FIG. 1 also illustrates a plurality of memory and input/output (I/O) interface components, such as flash memory 125, double data rate synchronous dynamic random access memory (DDR SDRAM) 127, and PCI card edge 120. In one embodiment, the hub of the design of integrated PCI card 100 is FSPOB 110, which may be a PowerPC™ based System on a Chip (SOC). FSPOB 110 provides industry standard interfaces, such as PCI, General Purpose Input/Output (GPIO), Inter-Integrated Circuit (I2C), Serial and Parallel ports, and Universal Serial Bus (USB), all illustrated extending from FSPOB 110 to various external connection points, to the right and left edges of the FIG. 1 illustration.

According to the illustrative embodiment, integrated PCI card 100 is configured in a PCI half-slot format and contains a sufficient amount of embedded DDR SDRAM 127 and flash memory 125 to load an operating system (OS). Furthermore, integrated PCI card 100 may be independently enabled with onboard firmware for boot strap power-on-reset and an independent power supply. In one embodiment, the independent power supply (not shown) may be implemented via a separate 5V DC brick power supply interface (not shown). Similarly, in an alternate embodiment, the independent power supply may be implemented via 5V DC supplied by a “stand-by” power supply from a system Advanced Technology Extended (ATX) form factor power supply (not shown) coupled to PCI card edge 120.

As depicted in FIG. 1, the architecture of integrated PCI card 100 is configured such that integrated PCI card 100 may be a bi-directional serial peripheral interface (SPI) device (i.e. slave or master) to enable extensive communication capability with the system under test (SUT). In an alternate embodiment, the I/O components of integrated PCI card 100 may be configured to detect environmental conditions and/or settings of the SUT. Similarly, in another embodiment, the I/O components of integrated PCI card 100 may be configured to be compatible with a variety of Digital to Analog (D-A) and Analog to Digital (A-D) devices.

Although FIG. 1 illustrates integrated PCI card 100 as including a hex display coupled to FPGA 115, in an alternate embodiment, integrated PCI card 100 may instead be configured to include additional display devices capable of displaying output (e.g. system status messages). In such an embodiment, output data, including the environmental conditions and/or settings of integrated PCI card 100, could be transmitted back to the script or graphical user interface (GUI) of the computer system(s) of a user(s) via serial, parallel or USB devices. Similarly, in another embodiment, external devices, such as serial-to-general-purpose-interface-bus (GPIB) converters, may be connected to the I/O ports of integrated PCI card 100 to enable the fall control of standard lab instrumentation, such as oscilloscopes, logic analyzers, function generators, power supplies, and thermal controllers. In yet another embodiment of the invention, USB ports included on integrated PCI card 100 could enable integrated PCI card 100 to have dramatically expanded memory resources. Such USB ports could be used, for example, to connect to external devices capable of functioning as portable replacements for Integrated Drive Electronics (IDE) or flash memory 125.

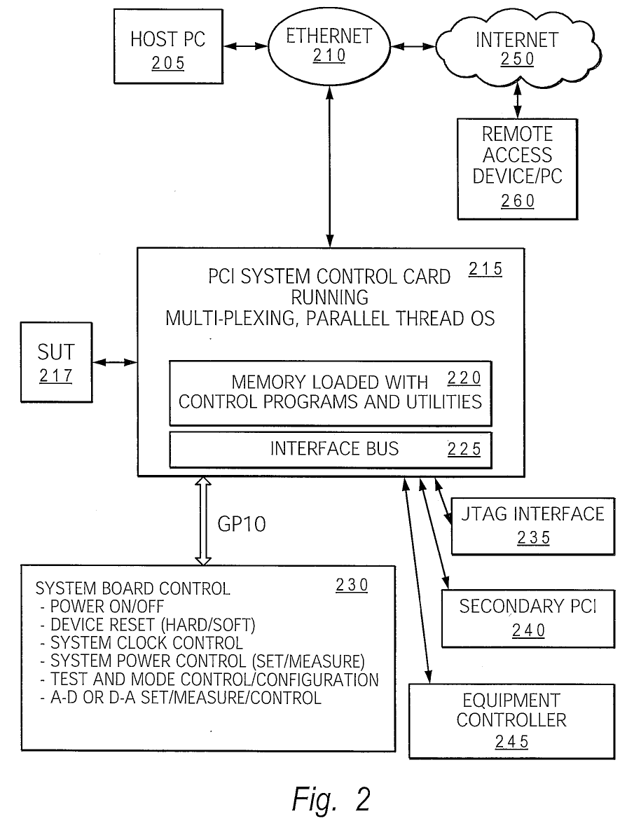

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

With reference now to FIG. 2, there is depicted a functional flow diagram of an example system/network within which integrated PCI card 100 (referred to as PCI system control card 215) operates, in accordance with an embodiment of the present invention. The overall system comprises host personal computer (PC) 205, PCI system control card 215, and a plurality of system board control functions 230. Host personal computer 205 is communicatively connected to PCI system control card 215 via Ethernet 210. Integrated PCI card 100 is communicatively connected to SUT 217. PCI system control card 215 includes memory 220, which may be loaded with control programs and/or utilities, and interface bus 225. FIG. 2 also illustrates I/O and other devices connected to PCI system control card 215, such as JTAG interface 235, secondary PCI 240, and equipment controller 245.

In an embodiment of the present invention, integrated PCI card 100 (PCI system control card 215) may be plugged directly into a PCI card slot of SUT 217. Upon power-on-reset (POR) of integrated PCI card 100, the OS of integrated PCI card 100 boot-straps itself to a ready prompt. In one embodiment, a user interface to the OS is provided via a conventional American National Standard Code for Information Interchange (ASCII) terminal coupled to one of the serial ports of integrated PCI card 100. In an alternate embodiment, integrated PCI card 100 could instead be utilized without plugging directly into a PCI card slot of SUT 217, for example by utilizing a wireless or network communication link.

Once PCI system control card 215 and its corresponding OS are powered up and ready to operate, external memory and/or resources may be accessed by integrated PCI card 100 via Ethernet 210. Ethernet 210 thus provides access to host PC 205, which contains commonly used scripts, system functions, system tools, system configurations, system controls, and the like. In one embodiment, some utilities, such as the system control software corresponding to SUT 217, may be loaded at boot time into memory 220. In an alternate embodiment, the system control software may already be included within memory 220.

As illustrated in FIG. 2, integrated PCI card 100 utilizes PCI system control card 215 coupled to one or more GPIO devices to control a plurality of system board control functions 230 of SUT 217. Among these functions are power on/off, device reset (hard/soft), system clock control, system power control (set/measure), test and mode control/configuration, and analog to digital (A-D) and/or digital to analog (D-A) set/measure/control. In one embodiment, Integrated PCI card 100 utilizes I2C and GPIO devices to drive and/or read any switch-able (i.e. controllable) device within SUT 217. Integrated PCI card 100 may also utilize JTAG interface 235 to perform a full debug of SUT 217. The present invention thus enables multiple remote users connected via the Ethernet (or larger network (e.g. internet 250 and remote access device 260) to control system clocks, power sequences, system controls, and any organization of timing sensitive and/or sequence sensitive devices within SUT 217.

It is understood that the use herein of specific names are for example only and not meant to imply any limitations on the invention. The invention may thus be implemented with different nomenclature/terminology and associated functionality utilized to describe the above devices/utility, etc., without limitation.

While an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A system comprising:
a board to which multiple devices may be coupled;
an embedded high performance microprocessor;
logic for providing system debugging within the a single PCI card;
logic for providing system boot up functions within the single PCI card; and
a plurality of industry standard interfaces that enable interconnection of said system with standard lab instrumentation.

2. The system of claim 1, wherein:
said system integrates multiple electrical system testing functions into a single, integrated peripheral component interconnect (PCI) card; and
the integrated functions comprise functions related to system bring-up and system debug.

3. The system of claim 1, further comprising:
a compact operating system (OS) that executes on the microprocessor and provides control over a plurality of the following functional features: (a) system-under-test (SUT) power on/off; (b) system device sequencing via programmable General Purpose Input/Output (GPIO); (c) system parametric control for one or more of voltage, temperature, and frequency; (d) system parametric measurement; and (e) system debug.

4. The system of claim 3, wherein said functional features controlled by said OS further comprises (f) remote control operation via an internet interface.

5. The system of claim 4, further comprising:
an instrumentation controller;
a Joint Test Action Group (JTAG) debugger;
a System Under Test (SUT) system controller; and
a computer-controlled GPIO card.

6. The system of claim 1, further comprising access ports for coupling input/output (I/O) devices that enable a user to control any portion of the SUT power sequence and all Inter-Integrated Circuit (I2C) and Serial Peripheral Interface (SPI) devices within the SUT.

7. The system of claim 6, further comprising means for:
receiving user settings and measurement of external system parameters, including temperature, voltage, and frequency to control IEEE-488 based instrumentation, such as oscilloscopes and logic analyzers; and
means for said user to utilize JTAG components in order to debug the SUT.

8. The system of claim 1, wherein said board comprises a PCI card.

9. The system of claim 8, wherein said PCI card is a single, self-aware, half-slot PCI card.

10. A PCI card configured according to claim 4.

11. A PCI card configured according to claim 5.

12. A PCI card configured according to claim 7.

13. A device for performing local and remote testing of a system under test (SUT), said device comprising:
an Integrated PCI card having:
a flexible support processor base chip (FSPOB);
a field programmable gate array (FPGA);
a plurality of memory and input/output (I/O) interface components;
a memory loaded with control programs and/or utilities; and
a compact operating system (OS) that executes on the microprocessor and provides control over a plurality of the following functional features: (a) system-under-test (SUT) power on/off, (b) system device sequencing via programmable General Purpose Input/Output (GPIO); (c) system parametric control for one or more of voltage, temperature, and frequency; (d) system parametric measurement; and (e) system debug.

14. The device of claim 13, wherein said FSPOB is System on a Chip (SOC), with a plurality of industry standard interfaces, including PCI, General Purpose Input/Output (GPIO), Inter-Integrated Circuit (I2C), Serial and Parallel ports, and Universal Serial Bus (USB), which all enable logic devices external to the SOC to connect to said FSPOB.

15. The device of claim 13, wherein said integrated PCI card is configured in a PCI half-slot format and contains:
embedded DDR SDRAM and flash memory;
logic for loading an operating system (OS);
onboard firmware for boot strap power-on-reset; and
an independent power supply couple to PCI card.

16. The device of claim 15, wherein further said integrated PCI card is configured as a bi-directional serial peripheral interface (SPI) device to enable extensive communication capability with a system under test (SUT).

17. The device of claim 16, said PCI card further comprising one or more I/O components configured to (1) detect one or more of: (a) environmental conditions; (b) settings of the SUT; and (2) provide compatibility with a plurality of Digital to Analog (D-A) and Analog to Digital (A-D) devices.

18. A system comprising:
a host personal computer (PC);
a PCI system control card designed with:
an embedded high performance microprocessor;
a plurality of system board control functions;
a memory loaded with control programs and/or utilities;
a compact operating system (OS) that executes on the microprocessor and provides control over a plurality of the following functional features: (a) system-under-test (SUT) power on/off; (b) system device sequencing via programmable General Purpose Input/Output (GPIO); (c) system parametric control for one or more of voltage, temperature, and frequency; (d) system parametric measurement; and (e) system debug; and
I/O and other devices connected to PCI system control card, such as JTAG interface, secondary PCI, and equipment controller;
wherein host personal computer is communicatively connected to PCI system control card via Ethernet; and
wherein integrated PCI card is communicatively connected to a System Under Test (SUT).

19. The system of claim 18, wherein:
said PCI system control card is plugged directly into a PCI card slot of the SUT;
when power-on-reset (POR) is triggered on said PCI system control card, an embedded OS of said PCI system control card boot-straps itself to a ready prompt

20. The system of claim 18, wherein said PCI system control card is connected to said SUT via a wireless or wired network communication link and comprises:
logic that, following powered up of said PCI system control card and loading of said OS, for accessing external memory and resources via Ethernet, wherein access is provided to the host PC, which contains commonly used scripts, system functions, system tools, system configurations, and system controls for interacting with said SUT;
logic for enabling one or more remote users to connect via a larger network to control system clocks, power sequences, system controls, and organization of timing sensitive and sequence sensitive devices within SUT;
means for coupling to one or more GPIO devices to control a plurality of system board control functions of SUT, from among power on/off, device reset (hard/soft), system clock control, system power control (set/measure), test and mode control/configuration, and analog to digital (A-D) and/or digital to analog (D-A) set/measure/control;
means for enabling use of I2C and GPIO devices to drive and/or read any switch-able (i.e. controllable) device within SUT; and
means for utilize a JTAG interface to perform a full debug of the SUT.
